(19) United States
(12) Patent Application Publication
(10) Pub. No.: US 2025/0103874 A1
(43) Pub. Date: Mar. 27, 2025

(54) MACHINE LEARNING MODEL TRAINING FOR AUTOMATED ENTITY UPDATE PROCESSING

(71) Applicant: Cigna Intellectual Property, Inc., Wilmington, DE (US)

(72) Inventors: Christopher Kurdelski, Philadelphia, PA (US); Jason Mack, Middletown, DE (US); Tze Sun Wong, Apleichau (HK); Diana Roxana Popescu Oprisoru, El Escorial (ES); Marco Cho Ho Ma, Hong Kong (HK); Simon Gould, Colyton (GB); Panagiotis Tzerefos, Knoxville, TN (US); Spencer Burridge, Lewisville, TX (US)

(21) Appl. No.: 18/371,646

(22) Filed: Sep. 22, 2023

(51) Int. Cl. G06N 3/08; G06F 40/117; G06F 40/279; G06N 3/0442

(52) U.S. Cl. CPC G06N 3/08; G06F 40/117; G06F 40/279; G06N 3/0442

(57) ABSTRACT

A method of machine learning model training for automated entity update processing includes obtaining a training set of multiple historical claims documents, extracting text portions from the training set of multiple historical claims documents, and generating training feature vectors. The method includes supplying the training feature vectors to a treatment identification machine learning model to train the treatment identification machine learning model to generate a prediction output, obtaining a target claim document, extracting text portions and identified text features from the target claim document, supplying the extracted text portions and the identified text features from the target claim document to the machine learning model, and automatically processing an entity update associated with the target claim document based on the prediction output of the correct entity value for the target claim document.

### FIELD

The present disclosure relates to systems and methods for machine learning model training for automated entity update processing.

### BACKGROUND

Unstructured information exists in documents related to healthcare claims. These documents vary greatly in their presentation, around the world. Gathering this information and making sense of it manually is a time-consuming task, requiring specialized resources. Because of this, much of this information is ignored and unused today. As a result, a full understanding of the health of the patient is not possible.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of machine learning model training for automated entity update processing includes obtaining a training set of multiple historical claims documents, each of the multiple historical claims documents including an associated entity value, extracting text portions from the training set of multiple historical claims documents, the extracted text portions including one or more identified text features, and generating training feature vectors based on the extracted text portions and the one or more identified text features. The method includes supplying the training feature vectors to a treatment identification machine learning model to train the treatment identification machine learning model to generate a prediction output, the prediction output indicative of a correct entity value for a claim document, obtaining a target claim document, extracting text portions and identified text features from the target claim document, supplying the extracted text portions and the identified text features from the target claim document to the machine learning model to generate a prediction output of the correct entity value for the target claim document, and automatically processing an entity update associated with the target claim document based on the prediction output of the correct entity value for the target claim document.

In other features, automatically processing the entity update includes automatically storing the prediction output of the correct entity value in a database as an entity field update associated with the target claim document.

In other features, automatically processing the entity update includes displaying the prediction output of the correct entity value on a user interface, receiving an input from a user in response to displaying the prediction output of the correct entity value on a user interface, and storing the input received from the user in a database as an entity field update associated with the target claim document.

In other features, the machine learning model includes a random forest tree-based model. In other features, extracting the text portions includes, for each text portion determining a position of the text portion, identifying one or more other text portions adjacent to the position of the text portion, and determining at least one qualitative indicator associated with each of the identified one or more other text portions.

In other features, the method includes classifying a page type of the target claim document via a page classification model, and supplying the classified page type to the machine learning model with the extracted text portions and the identified text features from the target claim document, to generate the prediction output of the correct entity value for the target claim document.

In other features, the page classification model is a machine learning classification model, and the method further includes obtaining a page classification training set, the page classification training set including multiple historical sample documents each tagged with an assigned page classification, and supplying the page classification training set to the machine learning classification model to train the machine learning classification model to generate a classification output indicative of a predicted page type of a claims document.

In other features, the page type includes at least one of a claim form, a pre-authorization document, a claim information document, a claim list, a correspondence document, an envoy page, an ID card, an invoice, a payment details document, a medical information document, a shipping label, or a system generated email.

In other features, the method includes supplying the prediction output of the machine learning model to a standardization model to conform a treatment type in the prediction output to a standard treatment type format, wherein the standard treatment type format includes at least one of a specified treatment claim type, a specified treatment category, a specified treatment sub-category, and a specified treatment detailed category.

In other features, the standardization model is a machine learning standardization model, and the method further includes obtaining a standard treatment type training set, the standard treatment type training set including multiple historical sample documents each tagged with at least one assigned treatment type category, and supplying the standard treatment type training set to the machine learning standardization model to train the machine learning standardization model to generate a standard format output indicative of a predicted standard treatment type of an identified treatment in a claims document.

In other features, the method includes assigning a unique code according to the standard treatment type format, wherein the unique code includes at least one of an ICD-10 code, a CPT code, an HCPCS code or a CDT code.

In other features, the method includes identifying, via a provider information model, at least one extracted text portion including a healthcare provider name, and removing the at least one extracted text portion including the healthcare provider name from the extracted text portions supplied to the machine learning model.

In other features, the target claim document includes a health insurance claim document or a prescription drug coverage claim document for a patient, and the prediction output of the machine learning model is a text portion of the health insurance claim document or a prescription drug coverage claim document including a treatment type for the patient.

A system for machine learning model training for automated entity update processing includes memory hardware configured to store computer-executable instructions, and a training set of multiple historical claims documents, each of the multiple historical claims documents including an associated entity value. The system includes processor hardware configured to execute the computer-executable instructions to perform a process including extracting text portions from the training set of multiple historical claims documents, the extracted text portions including one or more identified text features, generating training feature vectors based on the extracted text portions and the one or more identified text features, supplying the training feature vectors to a treatment identification machine learning model to train the treatment identification machine learning model to generate a prediction output, the prediction output indicative of a correct entity value for a claim document, obtaining a target claim document, extracting text portions and identified text features from the target claim document, supplying the extracted text portions and the identified text features from the target claim document to the machine learning model to generate a prediction output of the correct entity value for the target claim document, and automatically processing an entity update associated with the target claim document based on the prediction output of the correct entity value for the target claim document.

In other features, automatically processing the entity update includes automatically storing the prediction output of the correct entity value in a database as an entity field update associated with the target claim document.

In other features, automatically processing the entity update includes displaying the prediction output of the correct entity value on a user interface, receiving an input from a user in response to displaying the prediction output of the correct entity value on a user interface, and storing the input received from the user in a database as an entity field update associated with the target claim document.

In other features, the machine learning model includes a random forest tree-based model. In other features, extracting the text portions includes, for each text portion determining a position of the text portion, identifying one or more other text portions adjacent to the position of the text portion, and determining at least one qualitative indicator associated with each of the identified one or more other text portions.

In other features, the processor hardware is configured to execute the computer-executable instructions to further perform classifying a page type of the target claim document via a page classification model, and supplying the classified page type to the machine learning model with the extracted text portions and the identified text features from the target claim document, to generate the prediction output of the correct entity value for the target claim document.

In other features, the page classification model is a machine learning classification model, and the processor hardware is configured to execute the computer-executable instructions to further perform obtaining a page classification training set, the page classification training set including multiple historical sample documents each tagged with an assigned page classification, and supplying the page classification training set to the machine learning classification model to train the machine learning classification model to generate a classification output indicative of a predicted page type of a claims document.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a functional block diagram of an example system for automated entity update processing.

FIG. 5 is a message sequence chart illustrating example interactions between components of the system of FIG. 4.

FIGS. 6A and 6B are graphical representations of example recurrent neural networks for automated entity update processing.

FIG. 7 is a graphical representation of layers of an example long short-term memory (LSTM) machine learning model

FIG. 8 is a flowchart illustrating an example process for training a machine learning model

FIG. 9 is a flowchart depicting an example process for automated entity update processing.

FIG. 10 is a flowchart depicting an example process for extracting text features in the process of FIG. 9.

FIG. 11 is a flowchart depicting an example process for classifying page types in the process of FIG. 10.

FIG. 12 is a flowchart depicting an example process for identifying treatment types in the process of FIG. 9.

FIG. 13 is a flowchart depicting an example process for standardizing identified treatment types in the process of FIG. 9.

FIG. 14 is a flowchart depicting an example process for training a machine learning model.

In the drawings, reference numbers may be reused to identify similar and/or identical elements.

### DETAILED DESCRIPTION

### High-Volume Pharmacy

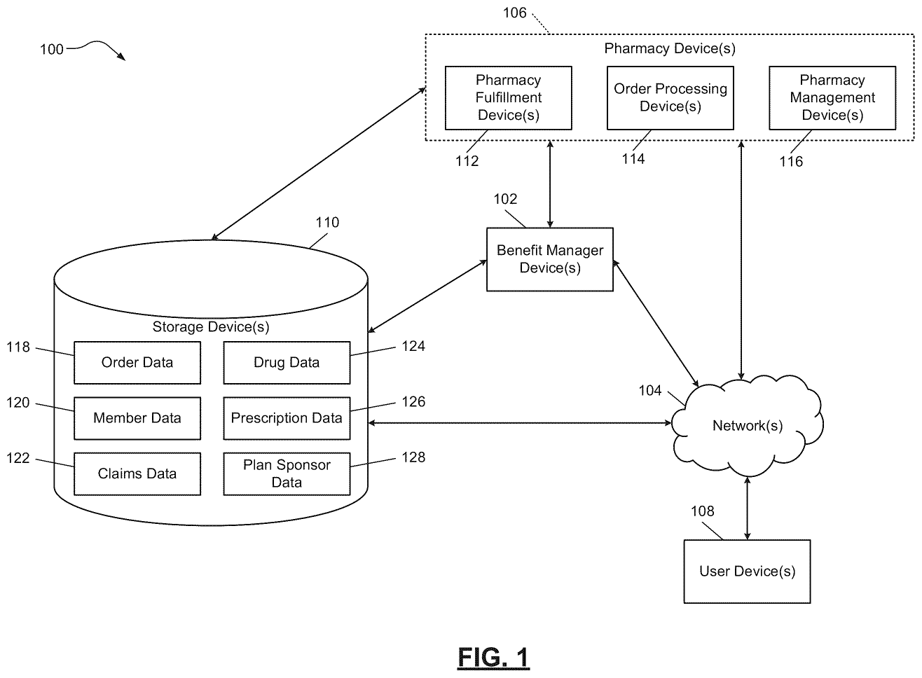

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug is successfully adjudicated. The aforementioned adjudication operations generally occur before the copayment is received and the prescription drug is dispensed. However, in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, address, telephone number, e-mail address, prescription drug history, etc. The member data 120 may include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally, or alternatively, the claims data 122 may include claims that have been de-identified (that is, associated with a unique identifier but not with a particular, identifiable member).

The drug data 124 may include drug name (e.g., technical name and/or common name), other names by which the drug is known, active ingredients, an image of the drug (such as in pill form), etc. The drug data 124 may include information associated with a single medication or multiple medications.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

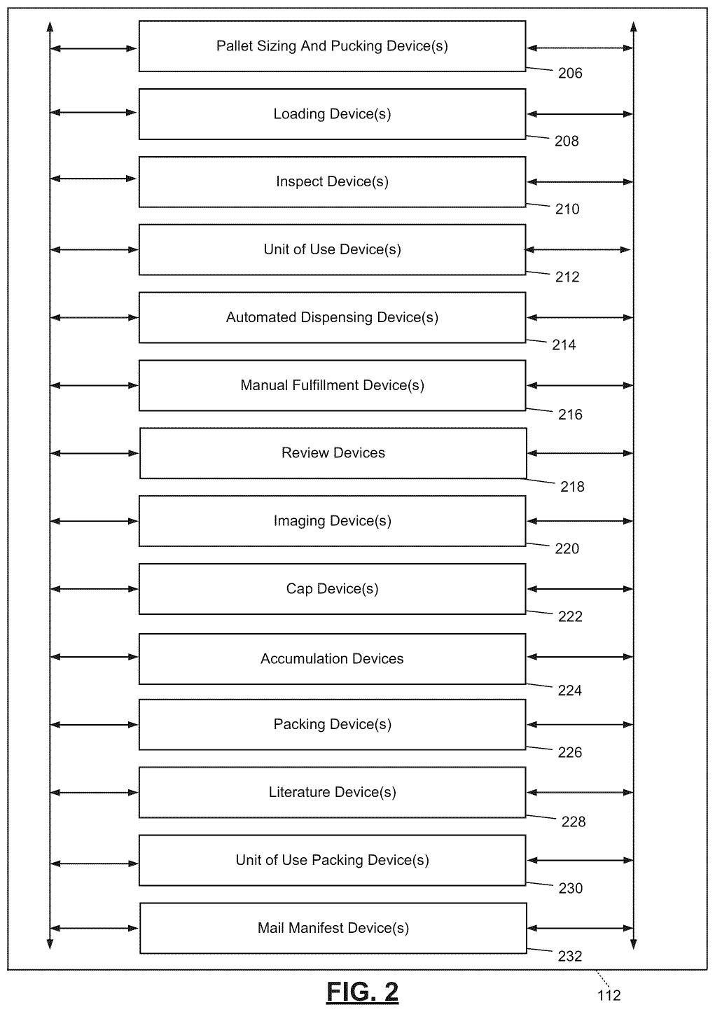

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

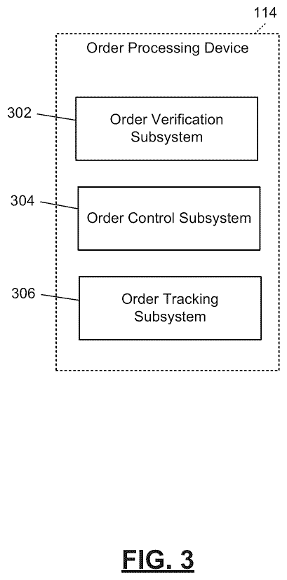

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Automated Entity Update Processing System

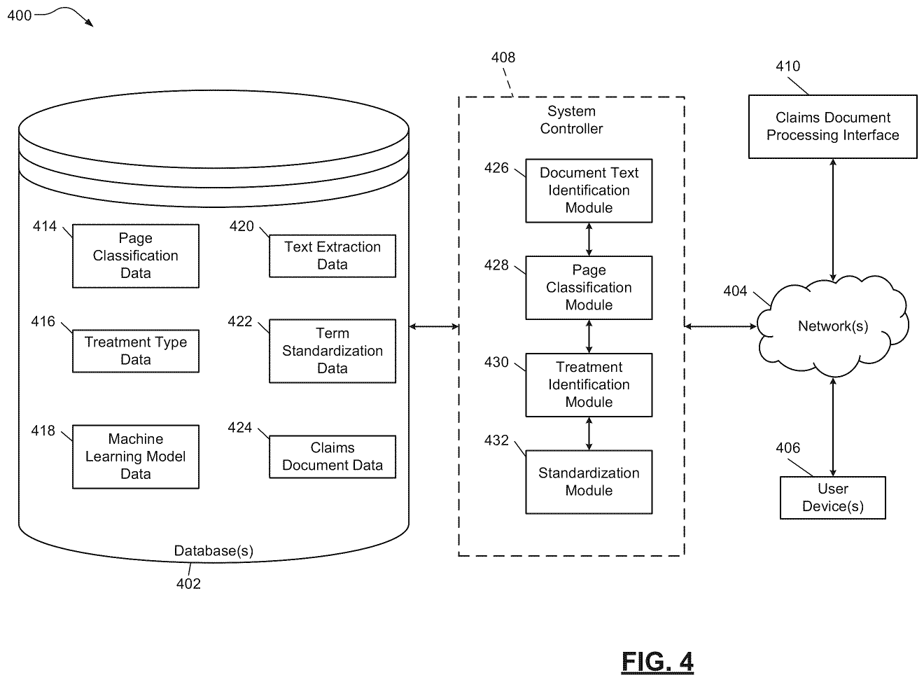

FIG. 4 is a functional block diagram of an example system 400 for automated entity update processing. While the system 400 is generally described as being deployed in a computer network system, the database 402, the system controller 408, the user device 406, the claims document processing interface 410, and/or components of the system 400 may otherwise be deployed (for example, as a standalone computer setup). The system 400 may include a desktop computer, a laptop computer, a tablet, a smartphone, etc.

As shown in FIG. 4, the page classification data 414, the treatment text data 416, the machine learning model data 418, the text extraction data 420, the term standardization data 422, and the claims document data 424, may be at least partially stored in one or more databases 402. In various implementations, the page classification data 414, the treatment text data 416, the machine learning model data 418, the text extraction data 420, the term standardization data 422, and the claims document data 424 may be located in different physical memories within a database or multiple databases, such as different random access memory (RAM), read-only memory (ROM), a non-volatile hard disk or flash memory, etc. In some implementations, the page classification data 414, the treatment text data 416, the machine learning model data 418, the text extraction data 420, the term standardization data 422, and the claims document data 424 may be located in the same memory (such as in different address ranges of the same memory). In various implementations, page classification data 414, the treatment text data 416, the machine learning model data 418, the text extraction data 420, the term standardization data 422, and the claims document data 424 may be located in structured or unstructured data in any suitable type of data store.

A system controller 408 includes multiple modules configured to operate on data stored in the database 402. For example, the document text identification module 426 may be configured to obtain claims document data 424, and identify text portions in the claims document to be stored as text extraction data 420, as explained in further detail below.

The page classification module 428 may be configured to use the page classification data 414 to classify a page type of the claims document data 424, as explained further below. The treatment identification module 430 may implement one or more trained machine learning models stored in the machine learning model data 418, to predict text in the claims document data 424 that correctly identifies a treatment type in the document. The standardization module 432 may be configured to apply the term standardization data 422 to identified treatment type text, in order to assign standardized treatment terminology to the identified text of the claim document which corresponds to the treatment type.

In various implementations, users (or software data systems) may interact with the system controller 408, via a user device 406. The user device 406 may include any suitable user device for displaying text and receiving input from a user, transmitting and receiving data over the network 404, etc., including a desktop computer, a laptop computer, a tablet, a smartphone, a server, etc. In various implementations, the user device 406 may access the system controller 408 directly, or through one or more networks 404. Example networks may include a wireless network, a local area network (LAN), the Internet, a cellular network, etc.

In some example embodiments, a claims document processing interface 410 may be configured to communicate with the system controller 408 directly, or via the network(s) 404. The claims document processing interface 410 may supply claims documents to the system controller 408, which may be stored in the claim document data 424 of the database 402.

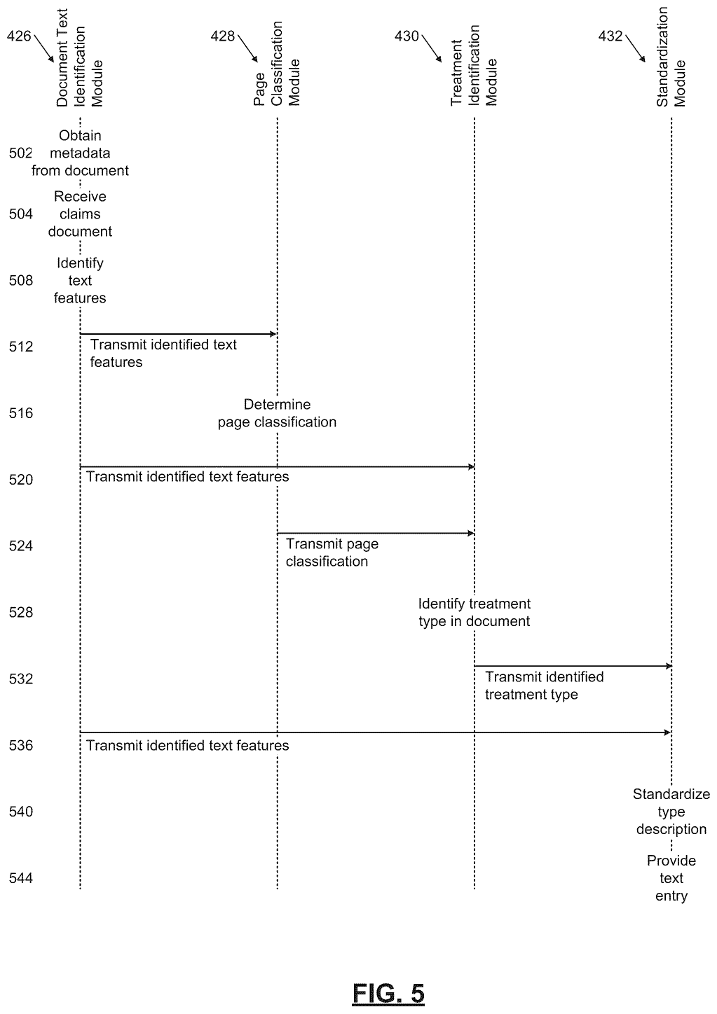

FIG. 5 is a message sequence chart illustrating example interactions between components of the system 400 of FIG. 4. FIG. 5 illustrates communications between the document text identification module 426, the page classification module 428, the treatment identification module 430 and the standardization module 432.

At line 502, the document text identification module 426 obtains document information from a document, such as metadata including a country of the document, a number of pages in the document, etc. This may be a separate data file, corresponding to each document itself. At line 504, the document text identification module 426 receives a claims document. For example, the document text identification module 426 may receive a claims document from an automated claims processing system, a user interface, etc.

At line 508, the document text identification module 426 identifies text features in the claims document. Identification of the text features may be an automated process, and may include identifying specific text, positions of portions of text relative to one another, classification of types of text, etc.

The document text identification module 426 then transmits identified text features to the page classification module 428, at line 512. The page classification module 428 determines a page classification at 516. Determining the page classification may include categorizing a type of claims document page, determining a sub-page classification within the parent page classification, etc.

At line 520, the document text identification module 426 transmits the identified text features to the treatment identification module 430. The page classification module 428 also transmits page classification information to the treatment identification module 430, at line 524.

At line 528, the treatment identification module 430 identifies the treatment type in the document. For example, a machine learning model may process identified text of the document to determine a treatment type listed in the document. The identified treatment type may be based on, for example, the identified text features transmitted from the document text identification module 426 and the determined page classification from the page classification module 428.

The treatment identification module 430 then transmits the identified treatment type to the standardization module 432, at line 532. The document text identification module 426 also transmits identified text features to the standardization module 432, at line 536.

At line 540, the standardization module 432 standardizes a treatment type description. For example, the identified treatment type may be matched with one or more standard categories, codes, listings, etc., for different treatment types. The standardization module 432 then provides a text entry, at line 544. For example, the text entry may be predicted by the standardization module (or the treatment identification module 430) as the correct identified treatment type in the claims document, which is standardized to the standard format, and may be presented on a screen for user input.

Alternatively, or in addition, a standardization module 432 may automatically enter the standardized type description text into an entity field, such as a data entry field corresponding to the claims document retrieved by the document text identification module 426 at line 504.

### Machine Learning Models

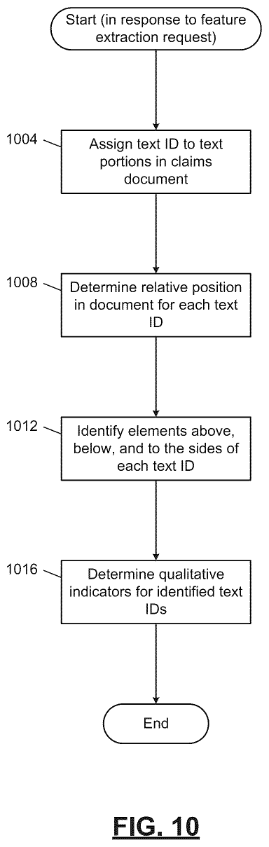

In various implementations, machine learning models may be used to automate and/or predict text for document field text entry (e.g., corresponding to identified treatment types, etc.). Examples of various types of machine learning models that may be used for automated document processing and text predictions are described below and illustrated in FIGS. 10-12, but example embodiments are not limited thereto.

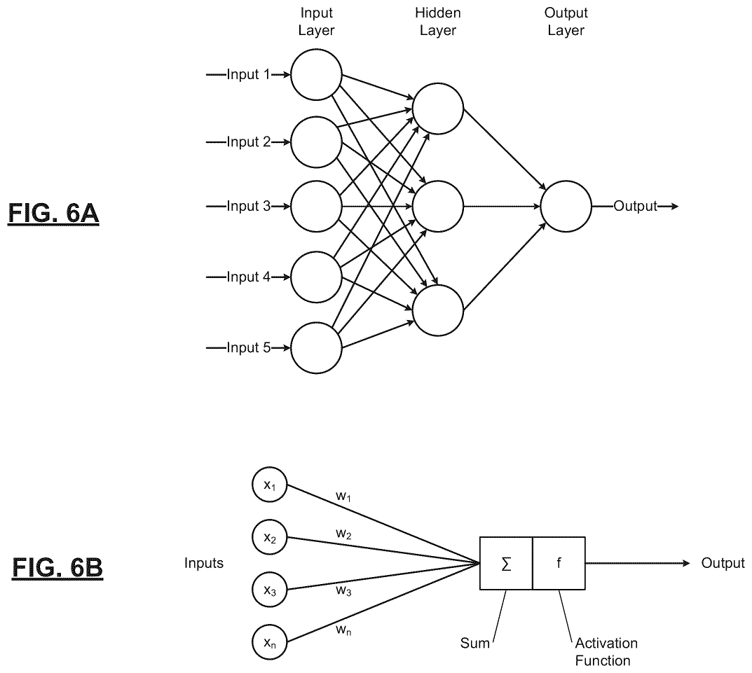

FIGS. 6A and 6B show an example of a recurrent neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the recurrent neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. The last layer is the output layer and produces output of the system.

FIG. 6A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 6B). In the input layer, the number of neurons equals number of features (columns) in a dataset. The output layer may have multiple continuous outputs.

The layers between the input and output layers are hidden layers. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure performance of a neural network model. For example, root mean squared error (RMSE) measures the average distance between observed values and model predictions. Coefficient of Determination (R²) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, that can be used to generate models that can be used with provider matching, risk model processing, or both, as described herein.

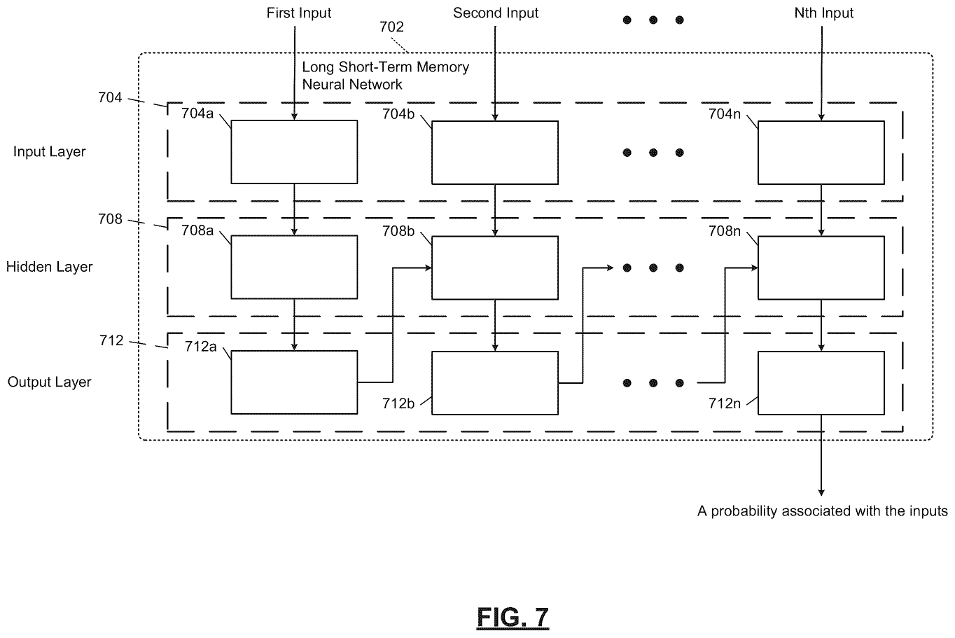

FIG. 7 illustrates an example of a long short-term memory (LSTM) neural network 702 used to generate models such as those described above, using machine learning techniques. The generic example LSTM neural network 702 may be used to implement a machine learning model, and various implementations may use other types of machine learning networks. The LSTM neural network 702 includes an input layer 704, a hidden layer 708, and an output layer 712. The input layer 704 includes inputs 704a, 704b . . . 704n. The hidden layer 708 includes neurons 708a, 708b . . . 708n. The output layer 712 includes outputs 712a, 712b . . . 712n.

Each neuron of the hidden layer 708 receives an input from the input layer 704 and outputs a value to the corresponding output in the output layer 712. For example, the neuron 708a receives an input from the input 704a and outputs a value to the output 712a. Each neuron, other than the neuron 708a, also receives an output of a previous neuron as an input. For example, the neuron 708b receives inputs from the input 704b and the output 712a. In this way the output of each neuron is fed forward to the next neuron in the hidden layer 708. The last output 712n in the output layer 712 outputs a probability associated with the inputs 704a-704n. Although the input layer 704, the hidden layer 708, and the output layer 712 are depicted as each including three elements, each layer may contain any number of elements.

In various implementations, each layer of the LSTM neural network 702 must include the same number of elements as each of the other layers of the LSTM neural network 702. In some embodiments, a convolutional neural network may be implemented. Similar to LSTM neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 704a is connected to each of neurons 708a, 708b . . . 708n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy. The neural network of FIG. 7 can receive inputs, e.g., vectors, that can be used to generate models that can be used with provider matching, risk model processing, or both, as described herein.

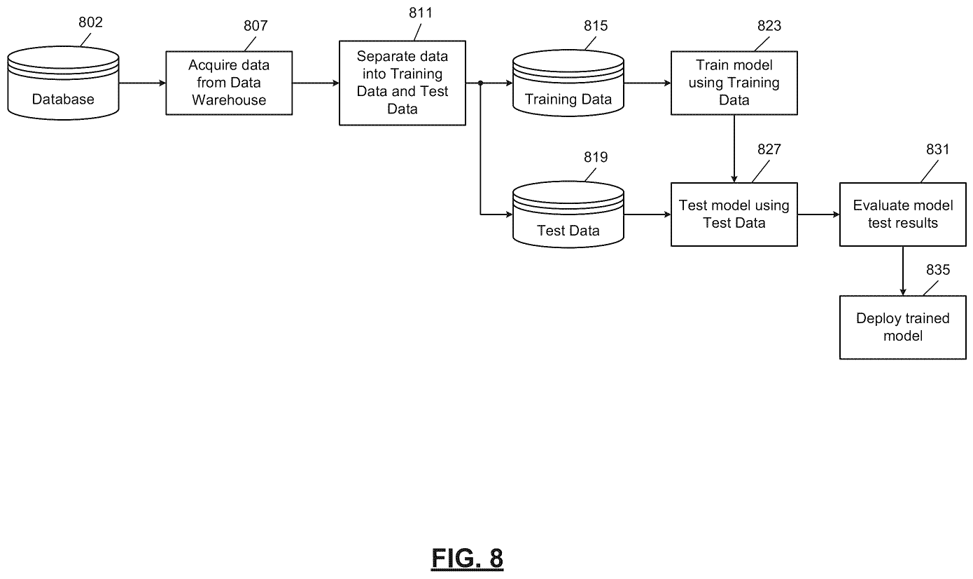

FIG. 8 illustrates an example process for generating a machine learning model. At 807, control obtains data from a database 802 (e.g., a data warehouse), such as the database 402. The data may include any suitable data for developing machine learning models.

At 811, control separates the data obtained from the database 802 into training data 815 and test data 819. The training data 815 is used to train the model at 823, and the test data 819 is used to test the model at 827. Typically, the set of training data 815 is selected to be larger than the set of test data 819, depending on the desired model development parameters. For example, the training data 815 may include about seventy percent of the data acquired from the database 82, about eighty percent of the data, about ninety percent, etc. The remaining thirty percent, twenty percent, or ten percent, is then used as the test data 819.

Separating a portion of the acquired data as test data 819 allows for testing of the trained model against actual output data, to facilitate more accurate training and development of the model at 823 and 827. The model may be trained at 823 using any suitable machine learning model techniques, including those described herein, such as random forest, generalized linear models, decision tree, and neural networks.

At 831, control evaluates the model test results. For example, the trained model may be tested at 827 using the test data 819, and the results of the output data from the tested model may be compared to actual outputs of the test data 819, to determine a level of accuracy. The model results may be evaluated using any suitable machine learning model analysis, such as the example techniques described further below.

After evaluating the model test results at 831, the model may be deployed at 835 if the model test results are satisfactory. Deploying the model may include using the model to make predictions for a large-scale input dataset with unknown outputs. If the evaluation of the model test results at 831 is unsatisfactory, the model may be developed further using different parameters, using different modeling techniques, using other model types, etc. The machine learning model method of FIG. 8 can receive inputs, e.g., vectors, that can be used to generate models that can be used with provider matching, risk model processing, or both, as described herein.

### Automated Entity Update Process

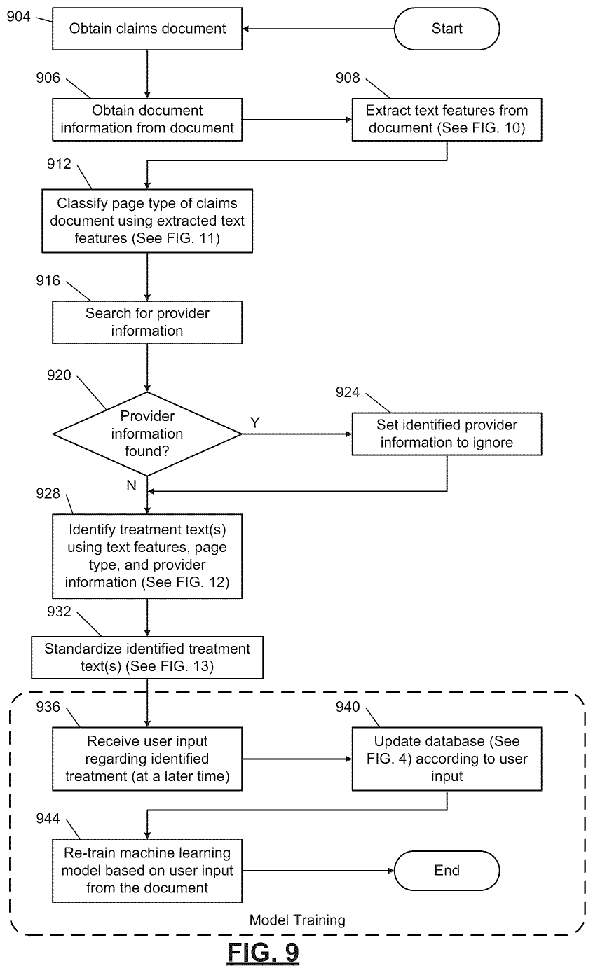

FIG. 9 is a flowchart depicting an example process for automated entity update processing. The process may be implemented by any suitable processor(s), including one or more modules of the system controller 408 of FIG. 4.

The process begins at 904 by obtaining a claims document. The claims document may be, for example, a document for an insurance claim or prescription coverage claim corresponding to treatment for a patient. Example document formats may include, but are not limited to, a PNG format, a JPEG format, a TIFF format, and a PDF format. In various implementations, the documents may be split into individual claim invoices, or tagged as individual claim invoices on their pages.

At 906, the process obtains document information from a document, such as metadata including a country of the document, a number of pages in the document, etc. This may be a separate data file, corresponding to each document itself. At 908, control extracts text features from the document. Additional example details regarding extracting text features from a document are described below with reference to FIG. 10. In some example embodiments, the text extraction may be performed by the document text identification module 426 of FIG. 4. In various implementations, text extraction may be performed by an automated service such as AWS Textract.

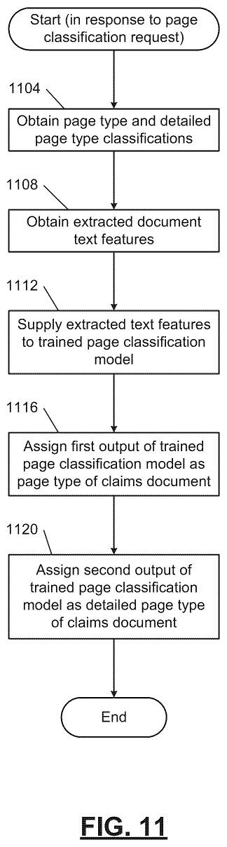

At 912, the system controller is configured to classify a page type of the claims document using the extracted text features. Additional example details of classifying the page type of the claims document using the extracted text features are described below with reference to FIG. 11. In some example embodiments, page classification may be performed by the page classification model 428 of the system controller 408 of FIG. 4.

The controller is configured to search for provider information at 916. For example, the controller may search the identified text to determine whether any of the text portions refer to provider information specifically. In some example embodiments, a provider model may score each piece of identified text, to estimate the likelihood that the piece of text is a healthcare provider name.

For example, a PyTorch Neural Network Model may use a Hugging Face SageMaker container, on top of a training set (which may include a list of provider names) and a pre-trained model. If the score is greater than a threshold (e.g., 50%), a yes/no flag representing “Is this text a provider text?” may be set to Y. This flag may be included as a feature for the treatment identification model.

If control determines at 920 that provider information is found in the text, control proceeds to 924 to set the identified provider information to ignore. For example, text identified as provider information may be considered as not including a treatment type, because that portion of the text is instead directed to a provider name or other provider information.

After setting the identified provider information to ignore at 924, or determining that no provider information was found in the extracted text at 920, control proceeds to 928 to identify treatment text(s), using text features, page type, provider information, etc. At 928, the identification of the treatment text(s) may be performed by a trained machine learning model, which has been trained to predict correct text that includes a treatment type as found within the extracted text and text features of the claims document.

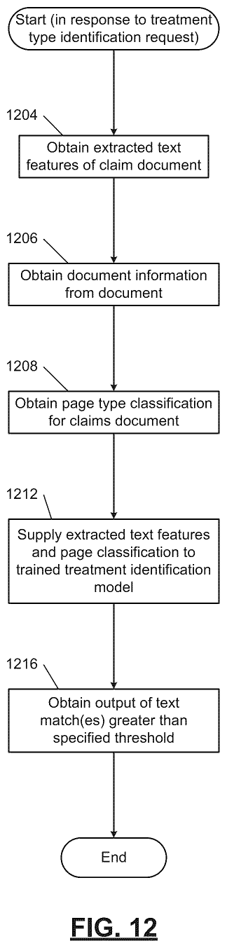

Further example details of identifying the treatment text(s) are described below with reference to FIG. 12. In some example embodiments, identifying the treatment text(s) may be performed by the treatment identification module 430 of the system controller 408 of FIG. 4.

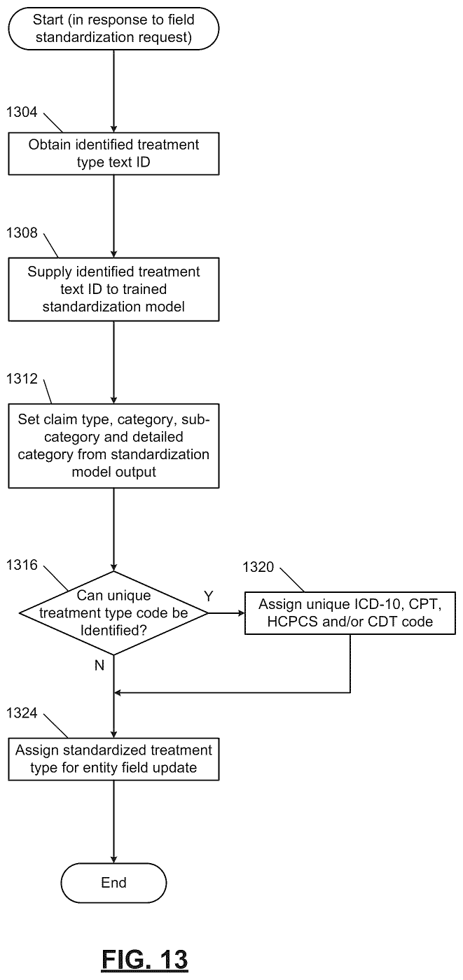

At 932, control standardizes the identified treatment text(s). For example, the treatment text(s) may be standardized into a format based on standard codes, names, categories, etc., each corresponding to different standard treatment text terminology. Additional details of standardizing identified treatment text(s) are described further below with reference to FIG. 13. In some example embodiments, the standardization of the identified treatment text(s) may be performed by the standardization module 432 of the system controller 408 of FIG. 4.

During model training (which may occur at a later time), the controller is configured to receive user input regarding the identified treatment at 936. The model training is indicated in broken lines in FIG. 9. For example, after standardizing the identified treatment text(s), the standard identified treatment text(s) may be displayed as the predicted correct treatment text(s) on a display of a user interface. The user may then confirm that the predicted treatment text(s) is in fact the correct text from the claims document, and enter the predicted correct treatment type text in an entry field corresponding to the claims document.

In some example embodiments, the system may automatically enter the identified text in a standard format into a database (such as the database 402 of FIG. 4) or other field associated with the claims documents. At 940, control updates the database (such as entity fields stored in the database 402 and associated with the claims document) according to the user input, or may automatically update the entity field based on the standardized identified treatment type text(s) (such as automatically storing the standardized identified treatment type text(s) in the database 402). At 944, the process may include retraining the machine learning model based on user input from the document.

FIG. 10 is a flowchart depicting an example process for extracting text features in the process of FIG. 9. In some example embodiments, the example process of FIG. 10 may be performed by the document text identification module 426 of the system controller 408 of FIG. 4.

The process begins in response to a feature extraction request, such as the feature extraction request at 908 of FIG. 9. At 1004, the controller is configured to assign a text ID to text portions in the claims document. For example, each portion of text within the claims document may be identified and assigned a specific identifier. In various implementations, the claims document may be supplied to an automated text extraction service, such as AWS Textract.

At 1008, control determines the relative position in the document for each text ID. For example, a location of each identified portion of text may be assigned coordinates within the boundaries of the claims document.

Control then identifies other text portions above, below, to the sides, etc., of each text ID. For example, control may identify what other text portions are or text IDs are located immediately above or below the current text ID, on a right or left side of the current text ID, etc. In various implementations, useful information and insights may be obtained by looking for information which is above or below the current text ID (such as a “Treatment” column header or row identifier, etc.).

In some example embodiments, text extraction outputs (such as AWS Textract outputs) may be used to calculate a relative position for each text ID (e.g., width, height, left, top). A relative position may be determined by re-centering the page, based on where the text is located.

For example, if a piece of text is halfway down a page, but is the last piece of text on the page, and the original top position value for the text was 0.50, a new relative value for the text may be equal to 0.50/0.50, or 1.00. In various implementations, text IDs may be identified above, below, left and right of the text ID in focus, using, e.g., a 0.01 rounding threshold, applied to the relative position of the text in focus.

At 1016, control determines qualitative indicators for identified text IDs adjacent the text ID in focus (or for the text ID in focus itself). For example, control may determine whether a portion of text contains a currency, only includes numbers, does not include any numbers at all, whether a length of an adjacent text ID is longer than the text ID in focus, whether no adjacent text is present at all, etc. Control may then pass the identified text and identified text features to the next module, such as the page classification module 428 of FIG. 4.

FIG. 11 is a flowchart depicting an example process for classifying page types in the process of FIG. 9. The process of FIG. 11 may be performed by, for example, the page classification module 428 of the system controller 408 of FIG. 4.

The process starts in response to a page classification request, such as the page classification request at 912 in the process of FIG. 9. At 1104, the controller is configured to obtain a page type classification and a detailed page type classification. For example, a list of possible page type classifications and detailed page type classifications may be stored, for mapping future claims documents. Below is a table of example page type classifications and detailed page type classifications, although other embodiments may use other classifications, more or less classifications, etc.

TABLE 1

| Page Type | Detailed Page Type |
|---|---|
| Claim Form | Claim Form |
| Claim Form | International Claim Form |
| Claim Form | Reimbursement Request |
| Claim Form | Partner Claim Form |
| Claim Form | Claims Transmittal Form |
| Claim Form | Cost Estimate Form |
| Claim Form | Dental Claim Form |
| Claim Form | Health Insurance Claim Form |
| Claim Form | Information Form |
| Claim Form | Medical Benefits Abroad |
| Claim Form | Provider Claim Form for Direct |
| Claim Form | Provider Claim Submission Cove |
| Claim Form | Reimbursement Claim Form |
| Claim Form | Request for Provider Appeal |
| — | — |
| Pre-Authorization | Approval |
| Pre-Authorization | Guarantee of Payment |
| — | — |
| Claim info and instructions | Coverage Information |
| Claim info and instructions | Claim Instructions |
| Claim info and instructions | Claim Processing Notes |
| — | — |
| Claim List | Claim List - List |
| Claim List | Claim List - Summary |
| — | — |
| Correspondence | Email |
| Correspondence | Letter to Member |
| Correspondence | Letter to Provider |
| Correspondence | Fax |
| — | — |
| Envoy Pages | Envoy Pages |
| — | — |
| ID Card | ID Card |
| — | — |
| Invoice | Commission Statement |
| Invoice | Explanation of Benefits |
| Invoice | Provider Specific Form |
| Invoice | Provider Specific Invoice |
| Invoice | Provider Specific Invoice Summary |
| — | — |
| Payment Details | Payment Confirmation |
| Payment Details | Payment Instructions |
| Payment Details | Request for Taxpayer |
| — | — |
| Medical Information | Prescription |
| Medical Information | Medical Report |
| Medical Information | Treatment Form |
| — | — |
| Shipping Label | Shipping Label |
| — | — |
| System Generated Email | System Generated Email |

At 1108, control obtains extracted text document text features, and then applies extracted text features to a trained page classification model at 1112. For example, a machine learning model may be trained to identify specific types of classifications of claims documents. The model may predict the type of the page, as well as detailed sub-page classifications depending on a configuration of the model.

In various implementations, a model may be trained by, for example, a team of human reviewers tagging each page of a sample of documents into the above categories. These classifications may be used as input to a treatment type identification model. If the page classification model is changed, the treatment identification model may be re-trained, based on the changed page classification model.

Control assigns the first output of the trained specification module as the page type classification of the claims document at 1116. The controller is configured to assign a second output of the trained page classification model as the detailed page type classification of the claims document at 1120. In some example embodiments, the model may only predict one page classification for a claims document, may predict multiple sub-classifications for a claims document, etc.

FIG. 12 is a flowchart depicting an example process for identifying treatment types in the process of FIG. 9. In some example embodiments, the process of FIG. 12 may be performed by the treatment identification module 430 of the system controller 408 of FIG. 4.

The process starts in response to a treatment type identification request, such as the treatment type identification request at 928 in FIG. 9. At 1204, the controller is configured to obtain extracted text features of the claims document. At 1206, the process obtains document information from a document, such as metadata including a country of the document, a number of pages in the document, etc. This may be a separate data file, corresponding to each document itself. Control also obtains the page type classification and any subtype classifications for the claims document, at 1208.

The controller is configured to supply the extracted text features and the page classification to a trained treatment identification module, at 1212. For example, a machine learning model may be trained to predict a correct treatment type within extracted text features of the claims document, and may receive input of a classification type of the claims document. Alternatively, multiple machine learning models may be trained for different page type classifications, and extracted text features may be supplied to a selected one of the machine learning model which has been trained on the determined page classification associated with the extracted text features.

At 1216, control obtains the output of text matches which are greater than a specified threshold. For example the machine learning model may output identified text ID's which have a certain matching value or predicted accuracy output from the trained model.

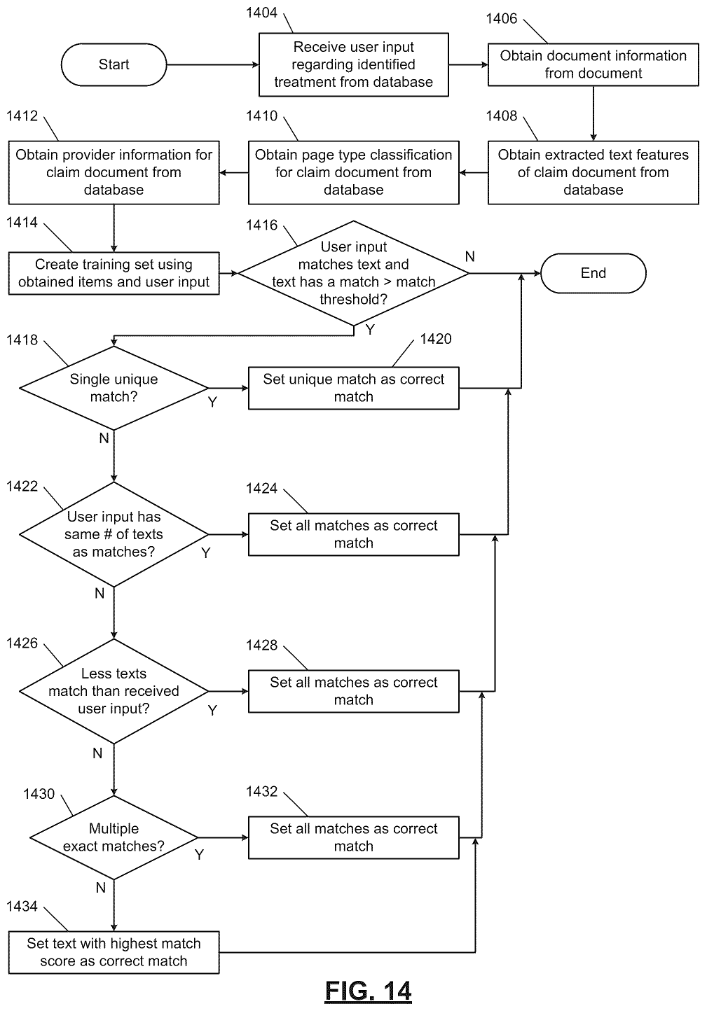

In some example embodiments, the model may be trained according to various machine learning training approaches. An example process is described below with reference to FIG. 14. In an example embodiment, control determines whether more than one text ID has been identified as being greater than a matching threshold based on the output of the machine learning model. If only one text ID has a matching score greater than a match threshold, control sets the determined text ID as the correct match. In this example, only one word or phrase from the claims document was identified as having a match score greater than the match threshold, so that text is stored as the predicted correct treatment type text.

If control determines that more than one text ID has a matching score greater than a match threshold, control determines whether multiple matches have identical text. If so, control assigns each text ID having the identical text to multiple correct match line items.

If control determines that there are multiple text IDs having a matching score greater than the match threshold, but the multiple text IDs have different text, control sets the highest matching score text ID as the correct match. In this example, multiple portions of the document have text ID matching scores above the threshold, so control selects the text ID having the highest matching score as the most likely correct answer for the identified treatment type in the claims document.

In some example embodiments, a model may be trained based on text that has been identified by data entry personnel as the correct ‘treatment type’ text in the claim document. The text entered by the data entry personnel is compared to each Textract text ID. If there is a threshold percentage match (e.g., at least 70%, using RapidFuzz, etc.), the text ID may be determined as the correct answer for training the model.

If there is more than one text ID determined to be a correct answer for text identified by data entry personnel (e.g., on a data entry form corresponding to the claims document), a de-duplication process may be performed, based on a principle of one best match for each answer.

For example, text from a page classification type of ‘envoy page’ may be discarded. If there are multiple matching answers, and they all have identical text, each identical matching answer may be kept (e.g., five physical therapy sessions may be presented as five line items).

From the remaining duplicates, an exact match may be attempted. If there is one exact match, the exact match text ID is used and the others are discarded. If there are multiple exact matches, all are kept in the training set (which may be addressed later in the run of the model, by de-duplicating the texts). If there are no exact matches, then the item with the highest text similarity may be used, and the others discarded. Below is a table of example model IDs and features, although other example embodiments may include more or less (or other) features.

TABLE 2

| | | field |
|---|---|---|
| Source | field | calculation |
| salesforce | salesforce claim ID | |
| salesforce | DCN | |
| salesforce | Capture Status | one of the |
| | | following: |
| salesforce | Correct Answer | mapping to |
| | | text ID, as |
| | | described |
| | | above |
| Metadata | Document Submission ID | |
| Metadata | Treatment Country | one-hot |
| | | encoding |
| Metadata | Document Language | one-hot |
| | | encoding |
| Textract | Text ID | |
| Textract | Text ID Score | no calculation |
| Textract | All Text in the document | no calculation |
| Textract + | Word by Word Flags, of Text from | vectorization |
| salesforce | the Text IDs that were determined to | |
| | be correct answers during training, | |
| | using the methods mentioned above, | |
| | but applied to all Text in the | |
| | document during model running | |
| Textract | Word by Word Flags, of Text to the | vectorization |
| | Left, Right, Above, and Below Text, | |
| | of Text ID, for all such text in the | |
| | training that had more than 10 | |
| | examples, and was selected as a | |
| | feature | |
| Textract + | Word by Word Flags, of Text to the | vectorization |
| Salesforce | Left, Right, Above, and Below Text, | |
| | of Text ID, for all such text in the | |
| | training that was determined to be a | |
| | correct answer, using the methods | |
| | mentioned above | |
| Textract | Relative Text Width | relative position |
| | | calculation, as |
| | | described above, |
| | | of width of text |
| Textract | Relative Text Height | relative position |
| | | calculation, as |
| | | described above, |
| | | of height of text |
| Textract | Relative Text Left | relative position |
| | | calculation, as |
| | | described above, |
| | | of left most part |
| | | of text |
| Textract | Relative Text Top | relative position |
| | | calculation, as |
| | | described above, |
| | | of highest part |
| | | of text |
| Translate | Language of Document | one-hot |
| | | encoding |
| Translate | All Text in the document | no calculation |
| Translate + | Word by Word Flags, of Text from | vectorization |
| Salesforce | the Text IDs that were determined to | |
| | be correct answers during training, | |
| | using the methods mentioned above, | |
| | but applied to all Text in the | |
| | document during model running | |
| Translate + | Flag for Correct Answer, by Text ID | approximate |
| Salesforce | | text matching, |
| | | based on a |
| | | 70% or greater |
| | | match |
| | | rate |
| Document | Page Type Prediction | one-hot |
| Classifier | | encoding |
| Provider | Local Business Name Confidence | one-hot |
| Model | Indicator | encoding |
| Provider | Model Score | no calculation |
| Model | | |

In some example embodiments, a feature selection model may be applied, given the large number of possible words in the vectorizer for left, right, above and below the focus text ID. The model may iteratively select, e.g., the top 10,000 features, from left, right, above and below text IDs, with a minimum of, e.g., ten examples. A tree-based model may be used, in Sci-Kit Learn, with any suitable parameters, such as 10 batches, a hyperparameter of 50, etc.′

Ten thousand final features may be constants which can be adjusted to optimize performance of the model as needed. In various implementations, a random forest optimizer may be used to create the model, with a model score threshold of, e.g., 0.5. This constant may be adjusted to optimize performance as needed.

FIG. 13 is a flowchart depicting an example process for standardizing identified treatment types in the process of FIG. 9. In some example embodiments, the process of FIG. 13 may be performed by the standardization module 432 of the system controller 408 of FIG. 4.

The process begins in response to a field standardization request such as the standardized treatment type request in 932 of FIG. 9. At 1304, control obtains an identified treatment type text ID. For example, an output of the trained machine learning model of the treatment identification module 430 may indicate a text ID within the extracted text features of the claims document that is most likely to be the correct identified treatment type.

At 1308, control supplies the standardized identified treatment text to a trained standardization model. For example, a machine learning model may be trained to identify standard codes, categories, subcategories, etc., for identified treatment types.

At 1312, the controller is configured to determine, for the identified treatment type text, a claim type, category, subcategory and detailed category, based on these standardized model output. In some example embodiments, training data for the model may be produced by medically trained staff, which groups a historic list of text descriptions into a claim type, a category, a sub-category, and a detailed category.

A logistic regression model may combine the four levels into one score, which may be used to select the best match from the possible categories. An example equation may be used to determine if a match is correct, such as Log R=−9.2-2.6*Claim type confidence+4.7*Category confidence+3.3*Subcategory confidence+1.2*Detailed category confidence. In various implementations, a result may be over 0.5 in order to determine a correct match. Other example embodiments may use other suitable models for combining the different categories.

Control determines at 1316 whether a unique treatment type code can be identified for the treatment type text, based on standardized output. If so, control proceeds to 1320 to assign a unique code, such as an ICD 10 code, a CDT code, a CPT code, an HCPCS code, a Hospital Revenue Code, etc.

After assigning a unique code 1320, or if control determines at 1316 that a unique treatment code cannot be identified, control proceeds to 1324 to assign a standardized treatment type for the entity field update. For example, a standardized treatment type may be displayed to a user for entry into an entity field associated with the claims document, a standard treatment type may be automatically stored in a database and entity fields associated with the claims document, etc.

In some example embodiments, some combination of categories may have a unique code, such as a unique ICD-10, CDT, CPT, HCPCS and/or Hospital Revenue code. These may be industry standard codes for diagnosis (ICD-10: International Classification of Diseases), medical procedures (CPT: US Current Procedural Terminology, and HCPCS: US Healthcare Common Procedure Coding System), dental procedures (CDT: US Current Dental Terminology), and hospital services (Hospital Revenue Codes).

Example processes described herein may be repeated periodically to re-train the models with additional examples over time, in order to update the models.

FIG. 14 is an example process for training a model. At 1404, control receives user input regarding an identified treatment from a database, such as the database 402 of FIG. 4. Control obtains document information from the database at 1406, such as metadata which includes a country of the document, a number of pages in the document, etc.

At 1408, control obtains extracted text features from the claim document, and then obtains a page type classification for the claim document from the database at 1410. At 1412, control obtains provider information for the claim document from the database.

At 1414, control creates a training set using the obtained items and received user input. For example, to create the training set, control may execute the steps 1416 through 1434. At 1416, control determines whether user input matches a text of the claim document from the database, and if that text has a match of greater than or equal to a match threshold value. If so, control proceeds to 1418 to determine if there is a single unique text that matches.

If a single unique text matches at 1418, control proceeds to 1420 to set the single unique text as the correct match. If control determines at 1418 that there are multiple texts that match, control proceeds to 1422 to determine whether the user input has a same number of texts as the matches. If so, control keeps all of the matching texts and sets all of the matching texts as a correct match at 1424. For example, if five texts on the document are “Physical Therapy Session”, and there are five user inputs, up to five texts E be set as the correct match.

If the user input does not have a same number of texts as the matches, control determines at 1426 whether there are less texts that match than the received user input. If so, control sets all matches as a correct match at 1428.

If there are more texts that match than the received user input at 1426, control proceeds to determine whether there are multiple exact matches at 1430. If so, control keeps all matches as correct matches at 1432, regardless of the number of texts in the received user input. If there are not multiple exact matches at 1430, control sets the text with the highest match score as the correct match at 1434.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method of machine learning model training for automated entity update processing, the method comprising:
obtaining a training set of multiple historical claims documents, each of the multiple historical claims documents including an associated entity value;
extracting text portions from the training set of multiple historical claims documents, the extracted text portions including one or more identified text features;
generating training feature vectors based on the extracted text portions and the one or more identified text features;
supplying the training feature vectors to a treatment identification machine learning model to train the treatment identification machine learning model to generate a prediction output, the prediction output indicative of a correct entity value for a claim document;
obtaining a target claim document;
extracting text portions and identified text features from the target claim document;
supplying the extracted text portions and the identified text features from the target claim document to the machine learning model to generate a prediction output of the correct entity value for the target claim document; and
automatically processing an entity update associated with the target claim document based on the prediction output of the correct entity value for the target claim document.

2. The method of claim 1, wherein automatically processing the entity update includes automatically storing the prediction output of the correct entity value in a database as an entity field update associated with the target claim document.

3. The method of claim 1, wherein automatically processing the entity update includes:
displaying the prediction output of the correct entity value on a user interface;
receiving an input from a user in response to displaying the prediction output of the correct entity value on a user interface; and
storing the input received from the user in a database as an entity field update associated with the target claim document.

4. The method of claim 1, wherein the machine learning model includes a random forest tree-based model.

5. The method of claim 1, wherein extracting the text portions includes, for each text portion:
determining a position of the text portion;
identifying one or more other text portions adjacent to the position of the text portion; and
determining at least one qualitative indicator associated with each of the identified one or more other text portions.

6. The method of claim 1, further comprising:
classifying a page type of the target claim document via a page classification model; and
supplying the classified page type to the machine learning model with the extracted text portions and the identified text features from the target claim document, to generate the prediction output of the correct entity value for the target claim document.

7. The method of claim 6, wherein the page classification model is a machine learning classification model, and the method further includes:
obtaining a page classification training set, the page classification training set including multiple historical sample documents each tagged with an assigned page classification; and
supplying the page classification training set to the machine learning classification model to train the machine learning classification model to generate a classification output indicative of a predicted page type of a claims document.

8. The method of claim 6, wherein the page type includes at least one of a claim form, a pre-authorization document, a claim information document, a claim list, a correspondence document, an envoy page, an ID card, an invoice, a payment details document, a medical information document, a shipping label, or a system generated email.

9. The method of claim 1, further comprising supplying the prediction output of the machine learning model to a standardization model to conform a treatment type in the prediction output to a standard treatment type format,
wherein the standard treatment type format includes at least one of a specified treatment claim type, a specified treatment category, a specified treatment sub-category, and a specified treatment detailed category.

10. The method of claim 9, wherein the standardization model is a machine learning standardization model, and the method further includes:
obtaining a standard treatment type training set, the standard treatment type training set including multiple historical sample documents each tagged with at least one assigned treatment type category; and
supplying the standard treatment type training set to the machine learning standardization model to train the machine learning standardization model to generate a standard format output indicative of a predicted standard treatment type of an identified treatment in a claims document.

11. The method of claim 9, further comprising assigning a unique code according to the standard treatment type format,
wherein the unique code includes at least one of an ICD-10 code, a CPT code, an HCPCS code or a CDT code.

12. The method of claim 1, further comprising:
identifying, via a provider information model, at least one extracted text portion including a healthcare provider name; and
removing the at least one extracted text portion including the healthcare provider name from the extracted text portions supplied to the machine learning model.

13. The method of claim 1, wherein:
the target claim document includes a health insurance claim document or a prescription drug coverage claim document for a patient; and
the prediction output of the machine learning model is a text portion of the health insurance claim document or a prescription drug coverage claim document including a treatment type for the patient.

14. A system for machine learning model training for automated entity update processing, the system comprising:
memory hardware configured to store computer-executable instructions, and a training set of multiple historical claims documents, each of the multiple historical claims documents including an associated entity value; and
processor hardware configured to execute the computer-executable instructions to perform a process including:
extracting text portions from the training set of multiple historical claims documents, the extracted text portions including one or more identified text features;
generating training feature vectors based on the extracted text portions and the one or more identified text features;
supplying the training feature vectors to a treatment identification machine learning model to train the treatment identification machine learning model to generate a prediction output, the prediction output indicative of a correct entity value for a claim document;
obtaining a target claim document;
extracting text portions and identified text features from the target claim document;
supplying the extracted text portions and the identified text features from the target claim document to the machine learning model to generate a prediction output of the correct entity value for the target claim document; and
automatically processing an entity update associated with the target claim document based on the prediction output of the correct entity value for the target claim document.

15. The system of claim 14, wherein automatically processing the entity update includes automatically storing the prediction output of the correct entity value in a database as an entity field update associated with the target claim document.

16. The system of claim 14, wherein automatically processing the entity update includes:
displaying the prediction output of the correct entity value on a user interface;
receiving an input from a user in response to displaying the prediction output of the correct entity value on a user interface; and
storing the input received from the user in a database as an entity field update associated with the target claim document.

17. The system of claim 14, wherein the machine learning model includes a random forest tree-based model.

18. The system of claim 14, wherein extracting the text portions includes, for each text portion:
determining a position of the text portion;
identifying one or more other text portions adjacent to the position of the text portion; and
determining at least one qualitative indicator associated with each of the identified one or more other text portions.

19. The system of claim 14, wherein the processor hardware is configured to execute the computer-executable instructions to further perform:
classifying a page type of the target claim document via a page classification model; and
supplying the classified page type to the machine learning model with the extracted text portions and the identified text features from the target claim document, to generate the prediction output of the correct entity value for the target claim document.

20. The system of claim 19, wherein the page classification model is a machine learning classification model, and the processor hardware is configured to execute the computer-executable instructions to further perform:
obtaining a page classification training set, the page classification training set including multiple historical sample documents each tagged with an assigned page classification; and
supplying the page classification training set to the machine learning classification model to train the machine learning classification model to generate a classification output indicative of a predicted page type of a claims document.
